(19) United States
(12) Patent Application Publication
(10) Pub. No.: US 2026/0188559 A1
(43) Pub. Date: Jul. 2, 2026

(54) SPIN INDUCTOR

(71) Applicant: TDK CORPORATION, Tokyo (JP)

(72) Inventors: Eiji SUZUKI, Tokyo (JP); Tomoyuki SASAKI, Tokyo (JP)

(73) Assignee: TDK CORPORATION, Tokyo (JP)

(21) Appl. No.: 18/860,156

(22) PCT Filed: Jul. 6, 2023
(86) PCT No.: PCT/JP2023/025134

§ 371 Date: Oct. 25, 2024

(51) Int. Cl. H01F 27/28; H01F 27/08

(52) U.S. Cl. CPC H01F 27/2804; H01F 27/08; H01F 2027/2809

(57) ABSTRACT

This spin inductor includes a wiring layer, a first ferromagnetic layer, and a first heat dissipation layer. The first ferromagnetic layer is in contact with a first surface of the wiring layer. The first heat dissipation layer and the wiring layer sandwich the first ferromagnetic layer in a laminating direction.

### TECHNICAL FIELD

The present disclosure relates to a spin inductor.

### BACKGROUND ART

An inductor, along with a resistor and a capacitor, is a major electronic component and is used in various electronic devices. A coil is an example of the inductor. There is a trade-off relationship between the size of the coil and the strength of the inductance, and it is difficult to achieve a large inductance with a small coil.

In recent years, attention has been focused on a new type of inductor that does not use coils. A new type of inductor that does not use coils is sometimes called an emergent inductor. For example, Patent Document 1, Non-Patent Document 1, and Non-Patent Document 2 disclose a new inductor that uses spin vibration (hereinafter, referred to as a spin inductor). Since the inductance magnitude of the spin inductor becomes larger as the element size becomes smaller, the inductor is attracting attention because both miniaturization and large inductance magnitude can be achieved.

### CITATION LIST

### Patent Document

Patent Document 1 PCT International Publication No. WO 2022/181069

### Non-Patent Document

Non-Patent Document 1 Yuta Yamane, Shunsuke Fukami, and Junichi Ieda, Physical Review Letters 128,147201(202).
Non-Patent Document 2 Yasufumi Arai and Jun'ichi Ieda. Journal of the Physical Society of Japan 92, 074705(2023).

### SUMMARY OF INVENTION

### Technical Problem

There is a demand for small inductors with large inductance. Emergent inductors, including spin inductors, are still in the research stage and have various problems. One of these problems is the heat dissipation of the spin inductors. The spin inductors have a structure in which thin films are laminated, and the heat generated by the current flowing through the thin films cannot be ignored.

The present disclosure has been made in view of the above circumstances and an object thereof is to provide a spin inductor with high heat dissipation efficiency.

### Solution to Problem

In order to solve the above problems, the present disclosure provides the following means.
(1) A spin inductor according to a first aspect includes a wiring layer, a first ferromagnetic layer, and a first heat dissipation layer. The first ferromagnetic layer is in contact with a first surface of the wiring layer. The first heat dissipation layer and the wiring layer sandwich the first ferromagnetic layer in a laminating direction.
(2) The spin inductor according to the above-described aspect may further include a first insulating layer. The first insulating layer may be located between the first ferromagnetic layer and the first heat dissipation layer in the laminating direction.
(3) In the spin inductor according to the above-described aspect, the first insulating layer may include an oxide or nitride of at least one selected from the group consisting of Si, Ta, Al, Mg, Si and Ti.
(4) In the spin inductor according to the above-described aspect, the first heat dissipation layer may cover all of the wiring layer and the first ferromagnetic layer when viewed from the laminating direction.
(5) The spin inductor according to the above-described aspect may further include a second heat dissipation layer. The first heat dissipation layer and the second heat dissipation layer may sandwich the wiring layer and the first ferromagnetic layer in the laminating direction.
(6) The spin inductor according to the above-described aspect may further include a first via wiring and a second via wiring. Each of the first via wiring and the second via wiring may be connected to the wiring layer, and the second heat dissipation layer may be located between the first via wiring and the second via wiring.
(7) In the spin inductor according to the above-described aspect, a longitudinal direction of the first heat dissipation layer may be a first direction, and a longitudinal direction of the second heat dissipation layer may intersect the first direction.
(8) In the spin inductor according to the above-described aspect, the wiring layer may include a main portion through which a current flows in the first direction and a first branch portion which branches off from the main portion. At least part of the first branch portion may extend along with the main portion at a position offset in a second direction intersecting the first direction.
(9) In the spin inductor according to the above-described aspect, the wiring layer may further include a second branch portion. At least part of the second branch portion may extend along with the main portion at a position offset in the second direction intersecting the first direction, and a gap may be present between the first branch portion and the second branch portion.
(10) The spin inductor according to the above-described aspect may further include a first connection portion that connects the first heat dissipation layer and the wiring layer.
(11) The spin inductor according to the above-described aspect may further include a first connection portion that connects the first heat dissipation layer and the wiring layer, and the first connection portion may be connected to the first branch portion of the wiring layer.
(12) The spin inductor according to the above-described aspect may further include a second connection portion that connects the first heat dissipation layer and the second heat dissipation layer.
(13) The spin inductor according to the above-described aspect may further include a third connection portion that connects the wiring layer, the first heat dissipation layer, and the second heat dissipation layer.
(14) In the spin inductor according to the above-described aspect, the first heat dissipation layer may include any one selected from the group consisting of Ta, NiCr, Ti, SIN, TIN, ferrite, Ni, and Fe,
(15) In the spin inductor according to the above-described aspect, the wiring layer may be configured to inject spins into the first ferromagnetic layer, and the magnetization of the first ferromagnetic layer may be configured to precess with the injected spins.

### BRIEF DESCRIPTION OF DRAWINGS

FIG. 1 is a cross-sectional view of a spin inductor according to a first embodiment.

FIG. 2 is a plan view of the spin inductor according to the first embodiment.

FIG. 3 is a schematic view illustrating a function of the spin inductor according to the first embodiment.

FIG. 4 is a cross-sectional view of a spin inductor according to a second embodiment.

FIG. 5 is a plan view of the spin inductor according to the second embodiment.

FIG. 6 is a plan view of a spin inductor according to a third embodiment.

FIG. 7 is a plan view of a spin inductor according to a fourth embodiment.

FIG. 8 is a cross-sectional view of a spin inductor according to a fifth embodiment.

FIG. 9 is a plan view of the spin inductor according to the fifth embodiment.

FIG. 10 is a plan view of a first modified example of the spin inductor according to the fifth embodiment.

FIG. 11 is a plan view of a second modified example of the spin inductor according to the fifth embodiment.

FIG. 12 is a cross-sectional view of a spin inductor according to a sixth embodiment.

FIG. 13 is a plan view of the spin inductor according to the sixth embodiment.

FIG. 14 is a cross-sectional view of a spin inductor according to a seventh embodiment.

FIG. 15 is a plan view of the spin inductor according to the seventh embodiment.

FIG. 16 is a plan view of a first modified example of the spin inductor according to the seventh embodiment.

FIG. 17 is an application example of the spin inductor according to this embodiment.

### DESCRIPTION OF EMBODIMENTS

Hereinafter, an embodiment will be described in detail with reference to the drawings. The drawings used in the following description may show characteristic parts in an enlarged scale for the sake of convenience in order to make the characteristics easier to understand, and the dimensional ratios of each component may differ from the actual ones. The materials, dimensions, and the like exemplified in the following description are merely examples, and the present disclosure is not limited thereto. They can be modified as appropriate within the scope of the effects of the present disclosure.

First, directions will be defined. A direction in which each layer extends is defined as the x direction, and the direction perpendicular to the x direction is defined as the y direction. For example, the first direction connecting a first via wiring 50 and a second via wiring 60 along a wiring layer 10 is defined as the x direction. The second direction perpendicular to the x direction within the xy plane is defined as, for example, the y direction. Further, the thickness direction of each layer is defined as the z direction. The x direction and the y direction are perpendicular to the z direction. The z direction is an example of the laminating direction.

### First Embodiment

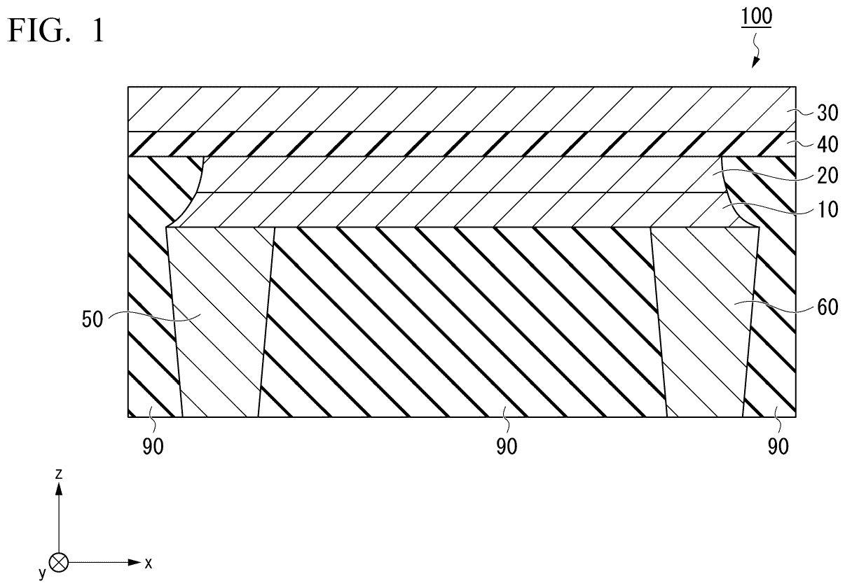

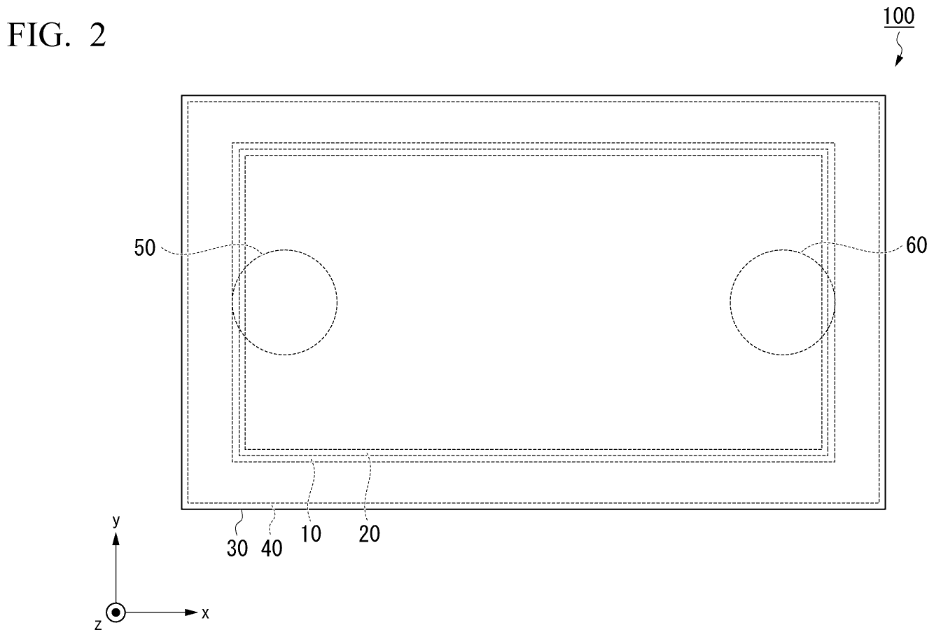

FIG. 1 is a cross-sectional view of a spin inductor 100 according to a first embodiment. FIG. 1 is a diagram showing the spin inductor 100 cut along the xy plane passing through the center of the wiring layer 10 in the y direction. FIG. 2 is a plan view of the spin inductor 100 according to the first embodiment. In FIG. 2, the components located below a first heat dissipation layer 30 are illustrated by dotted lines.

The spin inductor 100 includes the wiring layer 10, a first ferromagnetic layer 20, the first heat dissipation layer 30, a first insulating layer 40, the first via wiring 50, and the second via wiring 60.

The periphery of the spin inductor 100 is coated with an insulating layer 90. The insulating layer 90 is an insulating layer that provides insulation between wirings in a multilayer wiring structure and between elements, The insulating layer 90 may be made of a material similar to that used for insulating layers in semiconductor devices. The insulating layer 90 is, for example, silicon oxide (SiOₓ), silicon nitride (SiNₓ), silicon carbide (SiC), chromium nitride (CrN), silicon carbonitride (SiCN), silicon oxynitride (SiON), aluminum oxide (Al₂O₃), or zirconium oxide (ZrOₓ).

The spin inductor 100 is an inductor that functions by vibration of magnetization in a magnetic material. The spin inductor 100 cuts the high-frequency components of the current and passes the constant components of the current. The current flows between the first via wiring 50 and the second via wiring 60 along the wiring layer 10. The spin inductor 100 is disposed in a portion where it is desired to cut off high-frequency current. High-frequency current is cut by the spin inductor 100, but direct current flows through the spin inductor 100. For the direct current, the spin inductor 100 is a resistor.

The spin inductor 100 may include a plurality of inductor layers each including the wiring layer 10 and the first ferromagnetic layer 20. For example, a spacer layer is sandwiched between adjacent inductor layers. The spacer layer may be a conductor, a semiconductor, or an insulator.

The wiring layer 10 includes any one of a metal, an alloy, an intermetallic compound, a metal boride, a metal carbide, a metal silicide, and a metal phosphide, which has a function of generating a spin current by the spin Hall effect when a current flows. The wiring layer 10 may also be called spin-orbit torque wiring.

The wiring layer 10 includes, for example, a nonmagnetic heavy metal as a main component. Heavy metals refer to metals with a specific gravity equal to or greater than that of yttrium (Y). Non-magnetic heavy metals are, for example, non-magnetic metals with a large atomic number of 39 or more that have d electrons or f electrons in their outermost shell. The wiring layer 10 is made of, for example, Hf, Ta, or W. Nonmagnetic heavy metals have stronger spin-orbit interactions than other metals. The spin Hall effect is caused by the spin-orbit interaction. When spins tend to be unevenly distributed in the wiring layer 10 due to the spin Hall effect, a spin current J_{S} tends to be generated.

The wiring layer 10 may further include a magnetic metal. The magnetic metal is a ferromagnetic metal or an antiferromagnetic metal. A small amount of magnetic metal contained in a non-magnetic material acts as a scattering factor for spins. The small amount is, for example, 3% or less of the total molar ratio of the elements constituting the wiring layer. When spins are scattered by a magnetic metal, the spin-orbit interaction is enhanced, and the efficiency of generating a spin current relative to a current is increased.

The wiring layer 10 may include a topological insulator. The topological insulator is a material in which the interior is an insulator or highly resistive material, but a spin-polarized metallic state exists on the surface. The topological insulator has an internal magnetic field due to the spin-orbit interaction. The topological insulator exhibits a new topological phase due to the effect of the spin-orbit interaction even in the absence of an external magnetic field. The topological insulator can generate a pure spin current highly efficiently due to strong spin-orbit coupling and broken inversion symmetry at the edges, Further, since a current flows only on the surface of the topological insulator, a high current density can be achieved with a small amount of current.

Examples of the topological insulator are Sn, SnTe, Bi_{1.5}Sb_{0.5}Te_{1.7}Se_{1.3}, TlBiSe₂, Bi₂Te₃, Bi₁₋ₓSbx, (Bi₁₋ₓSbx)₂Te₃, and the like. The topological insulator is capable of generating a spin current with high efficiency.

The first ferromagnetic layer 20 is in contact with the first surface of the wiring layer 10. The first ferromagnetic layer 20 is in contact with, for example, the upper surface of the wiring layer 10.

The first ferromagnetic layer 20 is a ferromagnetic material. The ferromagnetic material is, for example, a metal selected from the group consisting of Cr, Mn, Co, Fe, and Ni, an alloy containing one or more of these metals, or an alloy containing these metals and at least one or more of the elements B, C, and N.

The ferromagnetic material is, for example, Co—Fe, Co—Fe—B, Ni—Fe, Co—Ho alloy, Sm—Fe alloy, Fe—Pt alloy, Co—Pt alloy, or CoCrPt alloy. A CoCrPt alloy and an Ll₀ type CoFe alloy have large saturation magnetization and strong magnetic anisotropy, and when these are used for the first ferromagnetic layer 20, the resonant frequency of the spin inductor 100 becomes high.

Further, the first ferromagnetic layer 20 may also be a magnetic insulator. When the first ferromagnetic layer 20 is a magnetic insulator, it is particularly preferable that the wiring layer 10 be a topological insulator. Since the current flows only at the bonding surface between the magnetic insulator and the topological insulator, current loss is reduced, and energy loss due to heat generation and the like can be suppressed.

Further, the first ferromagnetic layer 20 may also be a ferrimagnetic insulator or an antiferromagnetic insulator. When the first ferromagnetic layer 20 is an antiferromagnetic insulator, it is particularly preferable that the wiring layer 10 be a topological insulator. Since the current flows only at the bonding surface between the antiferromagnetic insulator and the topological insulator, current loss is reduced, and energy loss due to heat generation and the like can be suppressed. Furthermore, when the first ferromagnetic layer 20 is an antiferromagnetic insulator, the resonance frequency of the first ferromagnetic layer 20 becomes high, and the spin inductor does not cause resonance even in the high-frequency region of 10 GHz or more. Therefore, a spin inductor in which the first ferromagnetic layer 20 is an antiferromagnetic insulator can exhibit stable inductance over a wide band. For example, antiferromagnetic insulators include oxides containing magnetic elements such as NiO, MnO, Cr₂O₃, ferrite and garnet, sulfides containing magnetic elements such as MnS, and chlorides containing magnetic elements such as FeCl₂.

The first heat dissipation layer 30 is a layer that assists in dissipating heat generated in the inductor layer. The first heat dissipation layer 30 and the wiring layer 10 sandwich the first ferromagnetic layer 20 in the z direction. For example, the first heat dissipation layer 30 is adjacent to the first ferromagnetic layer 20 with the first insulating layer 40 interposed therebetween.

The first heat dissipation layer 30 includes, for example, any one selected from the group consisting of Ta, NiCr, Ti, SiN, TiN, ferrite, Ni, and Fe.

The first heat dissipation layer 30 covers the wiring layer 10 and the first ferromagnetic layer 20, for example, when viewed from the z direction. Since the first heat dissipation layer 30 covers the wiring layer 10 and the first ferromagnetic layer 20, the efficiency in dissipating the heat generated in the wiring layer 10 and the first ferromagnetic layer 20 is improved.

The first insulating layer 40 is located between the first ferromagnetic layer 20 and the first heat dissipation layer 30. The first insulating layer 40 includes, for example, an oxide or nitride of at least one selected from the group consisting of Si, Ta, Al, Mg, and Ti. The first insulating layer 40 is preferably made of a material having high thermal conductivity, such as MgO, AlN, SiN, or TiN.

When the first heat dissipation layer 30 is an insulator, the first insulating layer 40 may be omitted. When the first heat dissipation layer 30 is a conductor, it is preferable to provide the first insulating layer 40. When the first insulating layer 40 is located between the first heat dissipation layer 30 and the first ferromagnetic layer 20, some part of the current flowing through the wiring layer 10 is prevented from being diverted to the first heat dissipation layer 30, and a decrease in the current density of the current flowing through the wiring layer 10 can be suppressed.

The first via wiring 50 and the second via wiring 60 include a material having electrical conductivity. The first via wiring 50 and the second via wiring 60 are made of, for example, Cu, Al, Ag. Au, and the like, The first via wiring 50 is in contact with the wiring layer 10. The second via wiring 60 is in contact with the wiring layer 10 at a position different from the first via wiring 50. For example, the first via wiring 50 is connected to a first end of the wiring layer 10, and the second via wiring 60 is connected to a second end of the wiring layer 10. The first via wiring 50 and the second via wiring 60 extend in the z direction.

The spin inductor 100 may include a first terminal and a second terminal in contact with the side surfaces of the inductor layer instead of the first via wiring 50 and the second via wiring 60. Further, each of the first via wiring 50 and the second via wiring 60 may be in contact with the upper surface of the inductor layer.

The spin inductor 100 according to this embodiment can be produced by repeating a laminating step of laminating each layer and a processing step of processing each layer into a predetermined shape. The laminating step can be performed by, for example, a sputtering method, a chemical vapor deposition method (CVD method), an electron beam deposition method (EB deposition method), an atomic laser deposition method, and the like. The processing step can be performed by, for example, a photolithography method and the like.

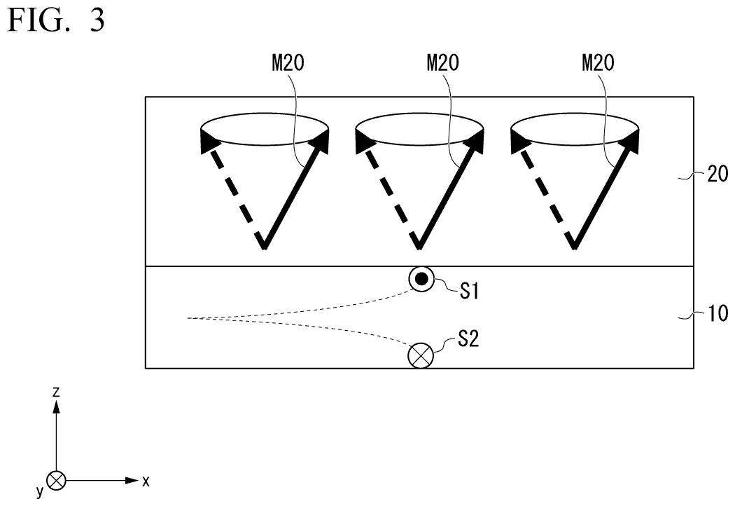

Next, the function of the spin inductor 100 will be described. FIG. 3 is a schematic view illustrating the function of the spin inductor 100.

The spin inductor 100 functions as an inductor when a current flows along the wiring layer 10. When a current is applied between the first via wiring 50 and the second via wiring 60, the current flows within the plane of the wiring layer 10.

The current flowing through the wiring layer 10 generates a spin current due to the spin Hall effect.

The spin Hall effect is a phenomenon in which a spin current is induced in a direction perpendicular to the direction of the flow of current (for example, the z direction) due to spin-orbit interaction when the current flows, The spin Hall effect is similar to the normal Hall effect in that the moving direction of moving charges (electrons) can be bent. In the normal Hall effect, the moving direction of charged particles moving within a magnetic field is bent by the Lorentz force. In contrast, in the spin Hall effect, the moving direction of spin is bent simply by the movement of electrons (the flow of current) even in the absence of the magnetic field.

For example, when a current flows in the x direction of the wiring layer 10, for example, spins S1 polarized in the-y direction are bent in the +z direction relative to the travel direction, and spins S2 polarized in the +y direction are bent in the −z direction relative to the travel direction.

The spins S1 generated by the wiring layer 10 are injected into the first ferromagnetic layer 20. Since the distance between the wiring layer 10 and the first ferromagnetic layer 20 is equal to or shorter than the spin diffusion length of the spins S1, the spins S1 generated by the wiring layer 10 can be efficiently injected into the first ferromagnetic layer 20. Another layer may be inserted between the wiring layer 10 and the first ferromagnetic layer 20.

The magnetization M20 of the first ferromagnetic layer 20 precesses due to the spins S1 injected from the wiring layer 10. The coercive force of the magnetization M20 and the magnitude of the current flowing through the wiring layer 10 are adjusted so that the magnetization M20 precesses without being reversed by the injected spins S1.

When the magnetization M20 of the first ferromagnetic layer 20 precesses, energy conversion occurs between the magnetic moment and the current, and the spin inductor 100 exhibits an inductor function.

From the viewpoint of maintaining the precession of the magnetization M20, the magnetization M20 preferably has a component oriented in the z direction or the x direction, and is more preferably oriented in the z direction in the initial state where neither an external magnetic field nor a current is applied to the spin inductor 100. Here, “no current flows” means a state in which no potential difference is applied to the wiring layer 10. Moreover, “no external magnetic field is applied” means a state in which no magnetic field is intentionally applied to the first ferromagnetic layer 20.

When the magnetization M20 is oriented in the y direction, magnetization reversal may occur and the magnetization precession may not be maintained even when no external magnetic field is applied. When the magnetization M20 is oriented in the x direction or the z direction, magnetization reversal is difficult to occur in the absence of the magnetic field. Since the spin inductor 100 exhibits an inductor function by using energy conversion between a magnetic moment and a current, the inductor function is not fully exhibited when the precession of magnetization stops.

Furthermore, even when the magnetization M20 is oriented in the y direction, it is possible to maintain the precession of the magnetization by adjusting the current density flowing through the wiring layer 10.

Since the spin inductor 100 generates a resonance phenomenon at the frequency of the ferromagnetic resonance of the first ferromagnetic layer 20, it is difficult for the spin inductor 100 to stably operate as an inductor near the resonance frequency. Therefore, the spin inductor 100 is used at a frequency sufficiently lower or sufficiently higher than the ferromagnetic resonance frequency of the spin inductor 100. The sufficiently low frequency or sufficiently high frequency generally indicates a frequency that is deviated from the ferromagnetic resonance frequency by 5% or more based on the ferromagnetic resonance frequency. The spin inductor 100 can generate inductance even at frequencies exceeding, for example, 10 GHz or 1 THz. Furthermore, the inductance generated by the spin inductor 100 is sufficient even if it is 1 nH or less.

Since the spin inductor 100 exhibits an inductor function by using energy conversion between a current and a magnetic moment, it is possible to exhibit a strong inductance even in a small size. For example, even if the maximum width of the spin inductor 100 when viewed in plan view from the z direction is 0.003 mm or less, an inductance of 0.1 μH or more and 10 μH or less can be achieved. Small inductance elements are particularly in demand in areas where it is difficult to incorporate large elements, such as in space and at cryogenic temperatures. Furthermore, even if the maximum width of the spin inductor 100 when viewed in plan view from the z direction is several hundreds of nm, the spin inductor 100 exhibits an inductance of several nH to several hundreds of nH even at the size having a length of several tens of nm.

As described above, the spin inductor 100 according to this embodiment functions as an inductor by the precession of the magnetization M20 of the first ferromagnetic layer 20 due to the spins injected from the wiring layer 10. This spin inductor 100 operates on a different principle than a coil and can be made smaller. For example, even if the maximum width of the spin inductor 100 when viewed in plan view from the z direction is 0.003 mm or less, inductance of 0.1 μH or more and 10 μH or less can be exhibited. Small inductance elements are particularly in demand in areas where it is difficult to incorporate large elements, such as in space and at cryogenic temperatures.

Further, the spin inductor 100 according to this embodiment can efficiently release heat from the first heat dissipation layer 30 even when heat is generated in the thin-film inductor layer.

### Second Embodiment

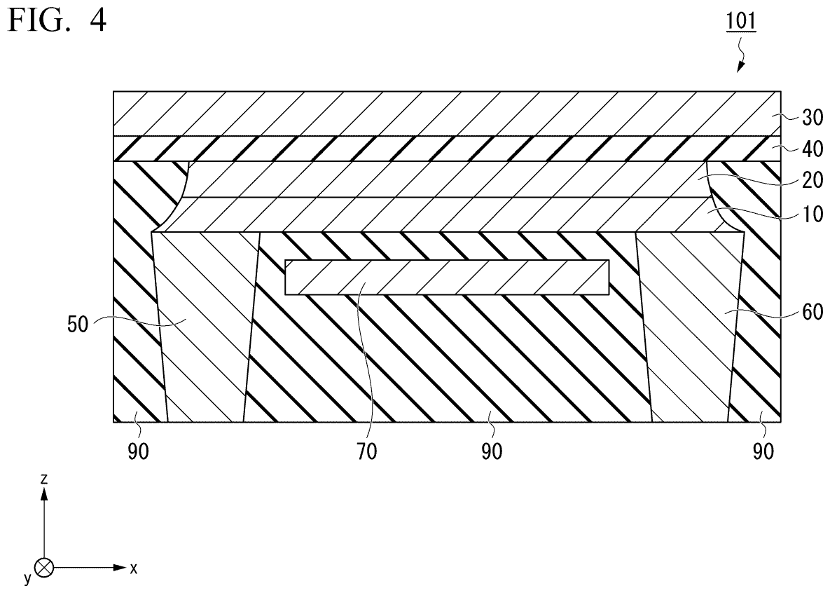

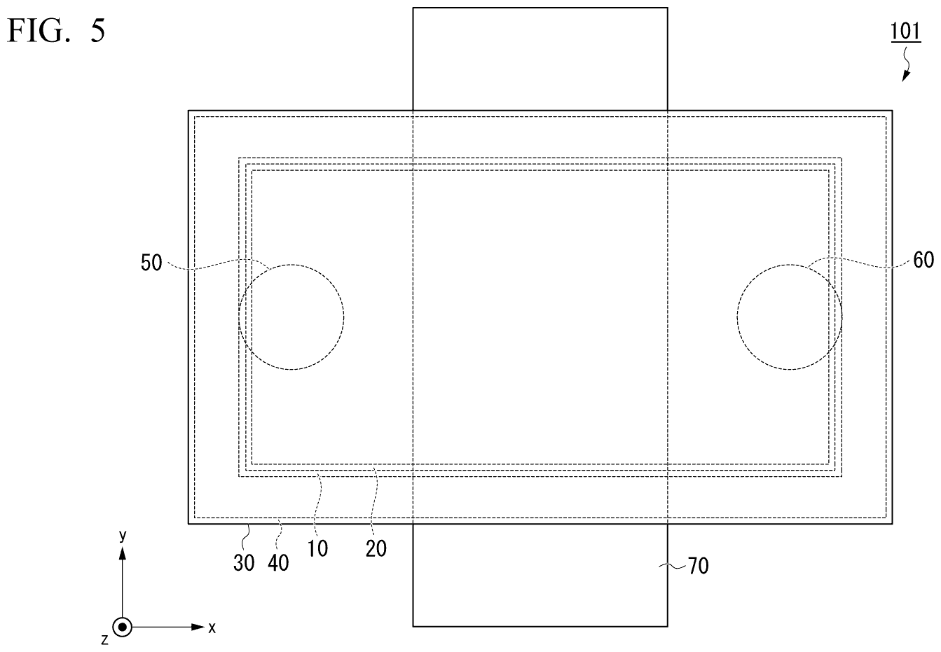

FIG. 4 is a cross-sectional view of a spin inductor 101 according to a second embodiment. FIG. 5 is a plan view of the spin inductor 101 according to the second embodiment. In the spin inductor 101 according to the second embodiment, the same components as those in the spin inductor 100 according to the first embodiment are designated by the same reference numerals, and the description thereof will be omitted.

The spin inductor 101 according to the second embodiment includes the wiring layer 10, the first ferromagnetic layer 20, the first heat dissipation layer 30, the first insulating layer 40, the first via wiring 50, the second via wiring 60, and a second heat dissipation layer 70. The spin inductor 101 is surrounded by the insulating layer 90. The spin inductor 101 is different from the spin inductor 100 according to the first embodiment in that the second heat dissipation layer 70 is provided.

The second heat dissipation layer 70 is located below the wiring layer 10. The second heat dissipation layer 70 and the first heat dissipation layer 30 sandwich the wiring layer 10 and the first ferromagnetic layer 20 in the z direction. The second heat dissipation layer 70 is located between the first via wiring 50 and the second via wiring 60 in the x direction.

The periphery of the second heat dissipation layer 70 is covered with the insulating layer 90, and the second heat dissipation layer 70 insulates the wiring layer 10, the first via wiring 50, and the second via wiring 60.

When viewed from the z direction, the longitudinal direction of the second heat dissipation layer 70 is the y direction. The second heat dissipation layer 70 is, for example, a rectangle whose longitudinal direction is the y direction. The longitudinal direction of the second heat dissipation layer 70 may be different from the longitudinal direction of the first heat dissipation layer 30. For example, as shown in FIG. 5, the longitudinal direction of the first heat dissipation layer 30 may be the x direction, and the longitudinal direction of the second heat dissipation layer 70 may be the y direction. Since the second heat dissipation layer 70 is formed in a rectangular shape with the y direction as the longitudinal direction, the second heat dissipation layer 70 with a large area can be disposed in the limited space between the first via wiring 50 and the second via wiring 60.

The spin inductor 101 according to the second embodiment has the same effects as the spin inductor 100 according to the first embodiment. Furthermore, the heat dissipation efficiency of the spin inductor 101 can be further improved by sandwiching an inductor layer that is likely to generate heat between the first heat dissipation layer 30 and the second heat dissipation layer 70.

### Third Embodiment

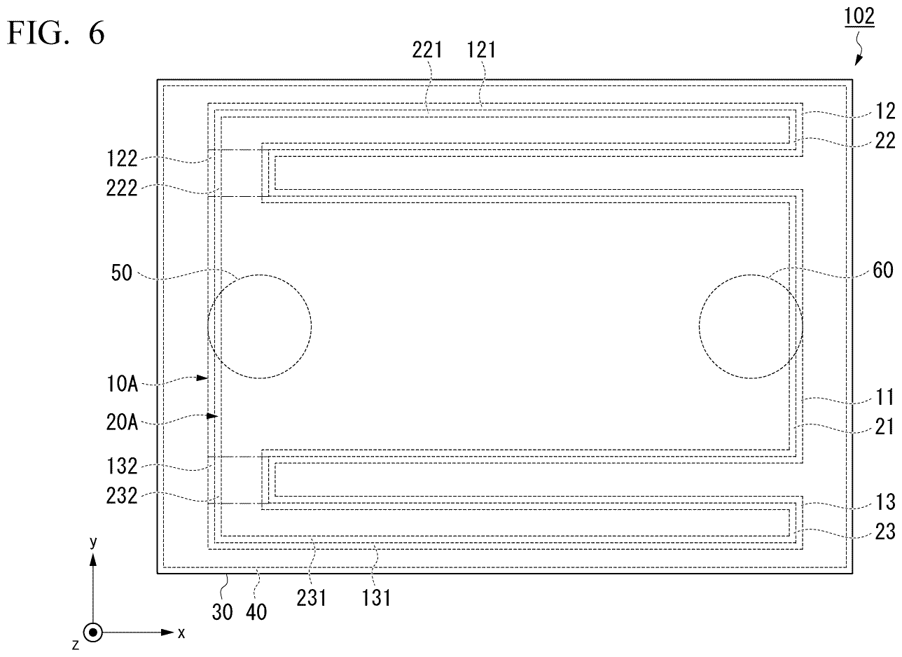

FIG. 6 is a plan view of a spin inductor 102 according to a third embodiment. The cross section of the spin inductor 102 according to the third embodiment is the same as that shown in FIG. 1. In the spin inductor 102 according to the third embodiment, the same components as those in the spin inductor 100 according to the first embodiment are designated by the same reference numerals, and the description thereof will be omitted.

The spin inductor 102 according to the third embodiment includes a wiring layer 10A, a first ferromagnetic layer 20A, the first heat dissipation layer 30, the first insulating layer 40, the first via wiring 50, and the second via wiring 60. In the spin inductor 102, the shapes of the wiring layer 10A and the first ferromagnetic layer 20A are different from those of the wiring layer 10 and the first ferromagnetic layer 20 of the spin inductor 100 according to the first embodiment.

The wiring layer 10A includes a main portion 11 and branch portions 12 and 13. The main portion 11 is a part that connects the first via wiring 50 and the second via wiring 60. Each of the branch portions 12 and 13 is a portion branched from the main portion 11. Each of the branch portions 12 and 13 is an example of the first branch portion.

The branch portion 12 includes a first part 121 and a second part 122. The first part 121 extends along the main portion 11 at a position offset from the main portion 11 in the y direction. The first part 121 may extend in a direction inclined from the x direction. The second part 122 is a part that connects the main portion 11 and the first part 121. The second part 122 protrudes from the main portion 11 with a component in the y direction.

Similarly, the branch portion 13 includes a first part 131 and a second part 132. The first part 131 extends along the main portion 11 at a position offset from the main portion 11 in the y direction. The first part 131 may extend in a direction inclined from the x direction. The second part 132 is a part that connects the main portion 11 and the first part 131. The second part 132 protrudes from the main portion 11 with a component in the y direction.

In the wiring layer 10A, most of the current flows through the main portion 11, and almost no current flows through the branch portions 12 and 13. In the main portion 11, the current flows in the x direction. The current density in the branch portions 12 and 13 is, for example, 1 A/cm² or less and preferably 0.1 A/cm² or less. Therefore, even when a current flows through the wiring layer 10A, the branch portions 12 and 13 do not generate much heat. The branch portions 12 and 13 dissipate heat generated in the main portion 11.

Further, the first ferromagnetic layer 20A includes a main portion 21 and branch portions 22 and 23. The main portion 21 is a part that connects the first via wiring 50 and the second via wiring 60. Each of the branch portions 22 and 23 is a portion branched from the main portion 21.

The branch portion 22 includes a first part 221 and a second part 222. The first part 221 extends along the main portion 21 at a position offset from the main portion 21 in the y direction. The first part 221 may extend in a direction inclined from the x direction. The second part 222 is a part that connects the main portion 21 and the first part 221. The second part 222 protrudes from the main portion 21 with a component in the y direction.

Similarly, the branch portion 23 includes a first part 231 and a second part 232. The first part 231 extends along the main portion 21 at a position offset from the main portion 21 in the y direction. The first part 231 may extend in a direction inclined from the x direction. The second part 232 is a part that connects the main portion 21 and the first part 231. The second part 232 protrudes from the main portion 21 with a component in the y direction.

In the first ferromagnetic layer 20A, most of the current flows through the main portion 21, and almost no current flows through the branch portions 22 and 23. In the main portion 21, the current flows in the x direction. The current density in the branch portions 22 and 23 is, for example, 1 A/cm² or less and preferably 0.1 A/cm² or less. The branch portions 22 and 23 dissipate heat generated in the main portion 21.

The spin inductor 102 according to the third embodiment has the same effects as the spin inductor 100 according to the first embodiment. Further, the branch portions 12, 13, 22, and 23 function as a heat dissipation path for the heat generated in the wiring layer 10A. Therefore, the spin inductor 102 according to the third embodiment has excellent heat dissipation properties. Further, since almost no current flows through the branch portions 12, 13, 22, and 23, the spin inductor 102 including the branch portions 12, 13, 22, and 23 does not significantly reduce the current density of the current flowing through the main portions 11 and 21.

Here, although an example has been described in which both the wiring layer 10A and the first ferromagnetic layer 20A include the branch portion, only one thereof may include the branch portion. That is, the wiring layer 10A may be replaced with the wiring layer 10, and the first ferromagnetic layer 20A may be replaced with the first ferromagnetic layer 20.

### Fourth Embodiment

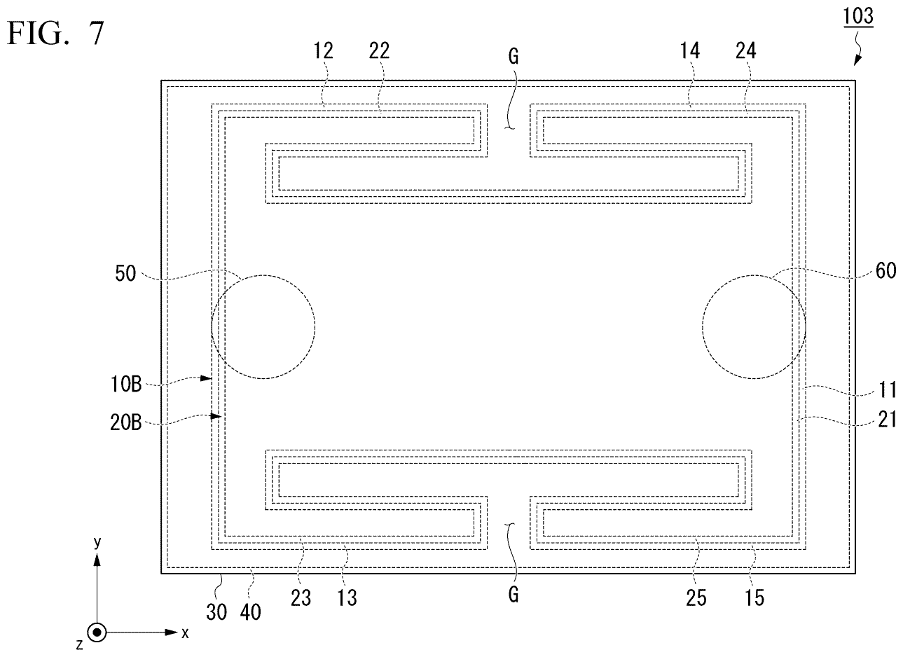

FIG. 7 is a plan view of a spin inductor 103 according to a fourth embodiment. The cross section of the spin inductor 103 according to the fourth embodiment is the same as that shown in FIG. 1. In the spin inductor 103 according to the fourth embodiment, the same components as those in the spin inductor 100 according to the first embodiment are designated by the same reference numerals, and the description thereof will be omitted.

The spin inductor 103 according to the fourth embodiment includes a wiring layer 10B, a first ferromagnetic layer 20B, the first heat dissipation layer 30, the first insulating layer 40, the first via wiring 50, and the second via wiring 60. In the spin inductor 103, the shapes of the wiring layer 10B and the first ferromagnetic layer 20B are different from those of the wiring layer 10 and the first ferromagnetic layer 20 of the spin inductor 100 according to the first embodiment.

The wiring layer 10B includes the main portion 11 and the branch portions 12. 13, 14, and 15. The main portion 11 is a part that connects the first via wiring 50 and the second via wiring 60. Each of the branch portions 12, 13, 14, and 15 is a portion branched from the main portion 11. Each of the branch portions 12, 13, 14, and 15 includes a portion that extends along the main portion 11 at a position offset from the main portion 11 in the y direction. Each of the branch portions 12 and 13 is an example of the first branch portion. Each of the branch portions 14 and 15 is an example of the second branch portion.

The branch portions 12 and 13 branch off from a first end of the main portion 11. The branch portions 14 and 15 branch off from a second end of the main portion 11. A gap G is present between the branch portion 12 and the branch portion 14, and the branch portion 12 and the branch portion 14 are not electrically connected to each other. Therefore, no current path is formed between the first via wiring 50 and the second via wiring 60 via the branch portion 12 and the branch portion 14. Similarly, a gap G is present between the branch portion 13 and the branch portion 15, and the branch portion 13 and the branch portion 15 are not electrically connected to each other. Therefore, no current path is formed between the first via wiring 50 and the second via wiring 60 via the branch portion 13 and the branch portion 15.

In the wiring layer 10B, most of the current flows through the main portion 11, and almost no current flows through the branch portions 12, 13, 14, and 15. In the main portion 11, the current flows in the x direction. The current density in the branch portions 12, 13, 14, and 15 is, for example, 1 A/cm² or less and 0.1 A/cm² or less. Therefore, even when a current flows through the wiring layer 10B, the branch portions 12, 13, 14, and 15 do not generate much heat. The branch portions 12, 13, 14, and 15 dissipate heat generated in the main portion 11.

The first ferromagnetic layer 20B includes the main portion 21 and the branch portions 22, 23, 24, and 25. The main portion 21 is a part that connects the first via wiring 50 and the second via wiring 60. Each of the branch portions 22, 23, 24, and 25 is a portion branched from the main portion 21. Each of the branch portions 22, 23, 24, and 25 includes a portion that extends along the main portion 21 at a position offset from the main portion 21 in the y direction.

The branch portions 22 and 23 branch off from a first end of the main portion 21. The branch portions 24 and 25 branch off from a second end of the main portion 21. A gap G is present between the branch portion 22 and the branch portion 24, and the branch portion 22 and the branch portion 24 are not electrically connected to each other. Similarly, a gap G is present between the branch portion 23 and the branch portion 25, and the branch portion 23 and the branch portion 25 are not electrically connected to each other.

In the first ferromagnetic layer 20B, most of the current flows through the main portion 21, and almost no current flows through the branch portions 22, 23, 24, and 25. In the main portion 21, the current flows in the x direction. The current density in the branch portions 22, 23, 24, and 25 is, for example, 1 A/cm² or less and 0.1 A/cm² or less. Therefore, even when a current flows through the first ferromagnetic layer 20B, the branch portions 22, 23, 24, and 25 do not generate much heat. The branch portions 22, 23, 24, and 25 dissipate heat generated in the main portion 21.

The spin inductor 103 according to the fourth embodiment has the same effects as the spin inductor 100 according to the first embodiment. Further, the branch portions 12, 13, 14, 15, 22, 23, 24, and 25 function as a heat dissipation path for the heat generated in the wiring layer 10B. Therefore, the spin inductor 103 according to the fourth embodiment has excellent heat dissipation properties.

Here, although an example has been described in which both the wiring layer 10B and the first ferromagnetic layer 20B include the branch portion, only one thereof may include the branch portion. That is, the wiring layer 10B may be replaced with the wiring layer 10, and the first ferromagnetic layer 20B may be replaced with the first ferromagnetic layer 20. Further, since almost no current flows through the branch portions 12, 13, 14, 15, 22, 23, 24, and 25, the spin inductor 103 including the branch portion 12, 13, 14, 15, 22, 23, 24, 25 does not significantly reduce the current density of the current flowing through the main portions 11 and 21.

### Fifth Embodiment

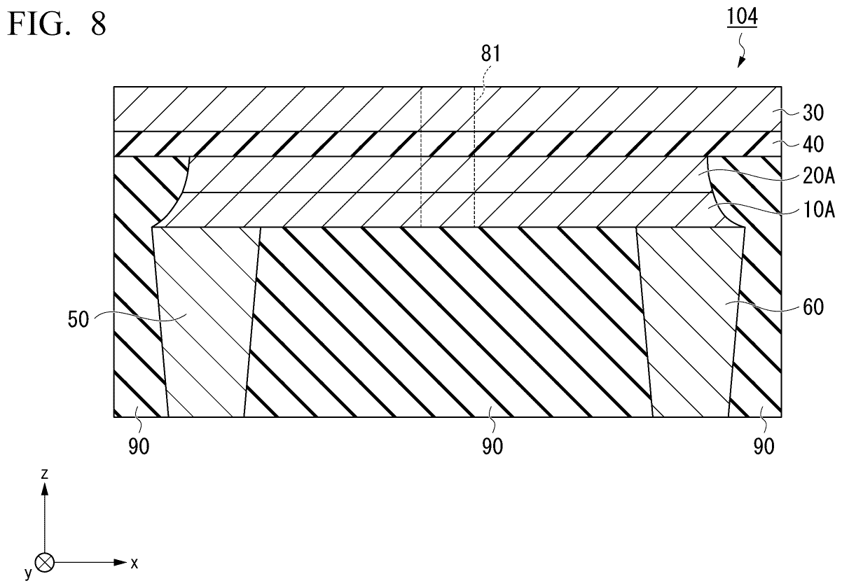

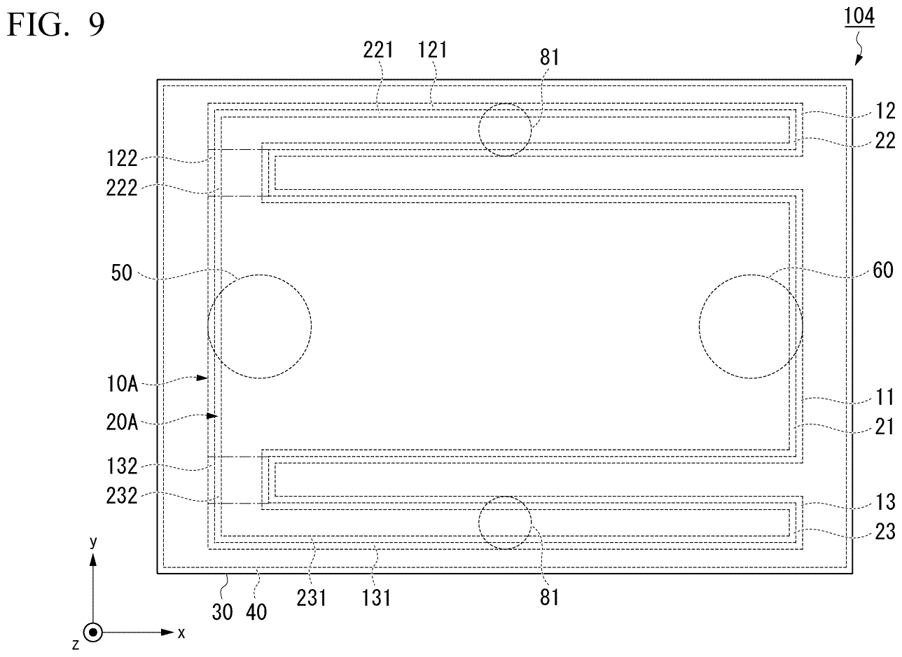

FIG. 8 is a cross-sectional view of a spin inductor 104 according to a fifth embodiment. FIG. 8 is a diagram showing the spin inductor 104 cut along the xz plane passing through the center of the wiring layer 10A in the y direction. In FIG. 8, the components on the front side of the page are illustrated by dotted lines. FIG. 9 is a plan view of the spin inductor 104 according to the fifth embodiment. In FIG. 9, the components located below the first heat dissipation layer 30 are illustrated by dotted lines. In the spin inductor 104 according to the fifth embodiment, the same components as those in the spin inductor 102 according to the third embodiment are designated by the same reference numerals, and the description thereof will be omitted, The spin inductor 104 according to the fifth embodiment includes the wiring layer 10A, the first ferromagnetic layer 20A, the first heat dissipation layer 30, the first insulating layer 40, the first via wiring 50, the second via wiring 60, and a connection portion 81. The spin inductor 104 is different from the spin inductor 102 according to the third embodiment in that the connection portion 81 is provided.

The connection portion 81 connects the wiring layer 10A and the first heat dissipation layer 30. The connection portion 81 is an example of the first connection portion. The connection portion 81 connects, for example, the branch portion 12 and the first heat dissipation layer 30. Further, the connection portion 81 connects, for example, the branch portion 13 and the first heat dissipation layer 30. Since almost no current flows through the branch portions 12 and 13, almost no current flows through the connection portion 81 and the first heat dissipation layer 30. Therefore, in the current flowing between the first via wiring 50 and the second via wiring 60, a current path is not formed in which the current flows through the branch portion 12 or the branch portion 13, the connection portion 81, and the first heat dissipation layer 30 in this order.

The connection portion 81 releases heat from the branch portions 12 and 13 toward the first heat dissipation layer 30. Therefore, the connection portion 81 suppresses heat generated in the main portion 11 from accumulating in the branch portions 12 and 13.

The spin inductor 104 according to the fifth embodiment has the same effects as the spin inductor 100 according to the first embodiment. Further, the branch portions 12, 13, 22, and 23 function as a heat dissipation path for the heat generated in the wiring layer 10A. Further, the connection portion 81 releases heat toward the first heat dissipation layer 30, thereby suppressing heat accumulation in the branch portions 12, 13, 22, and 23. The spin inductor 104 according to the fifth embodiment has excellent heat dissipation properties.

Here, although an example has been described in which the wiring layer 10A and the first heat dissipation layer 30 are connected by the connection portion 81, the spin inductor according to the fifth embodiment is not limited to this example.

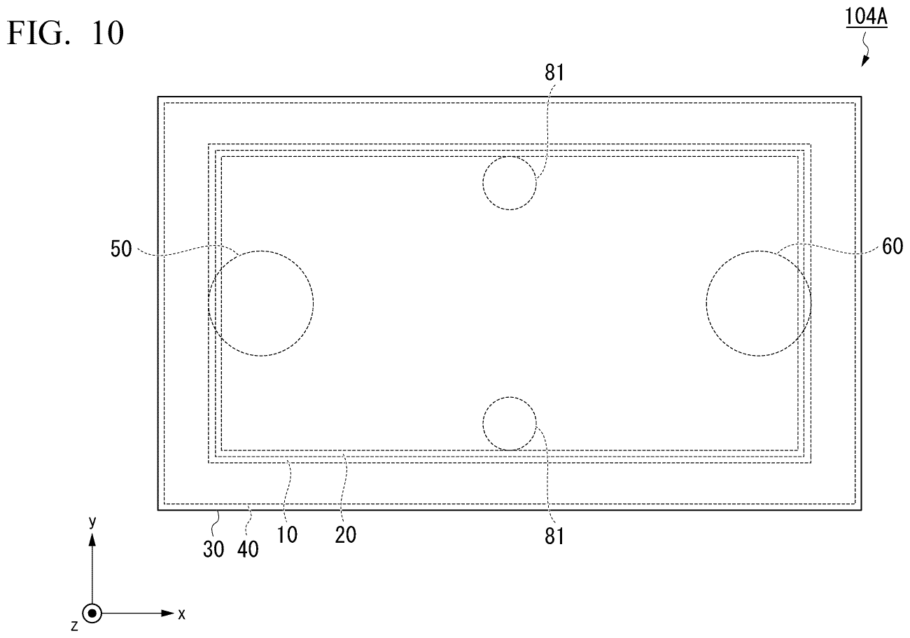

FIG. 10 is a plan view of a first modified example of the spin inductor according to the fifth embodiment. A spin inductor 104A according to the first modified example is different from the spin inductor 104 shown in FIG. 9 in that the wiring layer 10A is the wiring layer 10 and the first ferromagnetic layer 20A is the first ferromagnetic layer 20.

The spin inductor 104A includes the connection portion 81 that connects the wiring layer 10 and the first heat dissipation layer 30. The connection portion 81 is preferably located at a position offset in the y direction from the straight line connecting the first via wiring 50 and the second via wiring 60. Even in the spin inductor 104 according to the first modified example, heat generated in the wiring layer 10 can be efficiently transferred to the first heat dissipation layer 30. The spin inductor 104A generates current loss via the connection portion 81, but has high heat dissipation properties.

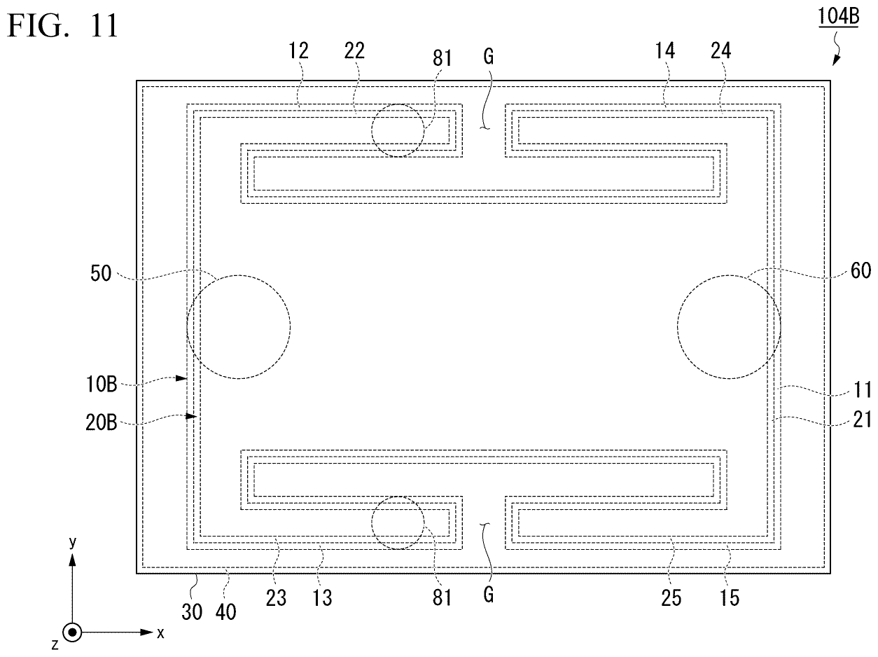

FIG. 11 is a plan view of a second modified example of the spin inductor according to the fifth embodiment. A spin inductor 104B according to the second modified example is different from the spin inductor 104 shown in FIG. 9 in that the wiring layer 10A is the wiring layer 10B and the first ferromagnetic layer 20A is the first ferromagnetic layer 20B. The configurations of the wiring layer 10B and the first ferromagnetic layer 20B are the same as those shown in FIG. 7.

The spin inductor 104B includes the connection portion 81 that connects the wiring layer 10B and the first heat dissipation layer 30. The connection portion 81 connects, for example, the branch portion 12 or the branch portion 13 and the first heat dissipation layer 30. For example, when one connection portion 81 is connected to the branch portion 12, the other connection portion is preferably connected to the branch portion 13. For example, when one connection portion 81 is connected to the branch portion 12 and the other connection portion 81 is connected to the branch portion 15, a current path is formed through the first via wiring 50, the branch portion 12, the first heat dissipation layer 30, the connection portion 81, the branch portion 15, and the second via wiring 60, thereby causing current loss.

Further, the first heat dissipation layer 30 may be divided into a plurality of regions, and each region may be electrically insulated. In this case, since the current that has reached part of the first heat dissipation layer 30 from the connection portion 81 cannot reach other regions, a current path that causes current loss is less likely to be formed.

### Sixth Embodiment

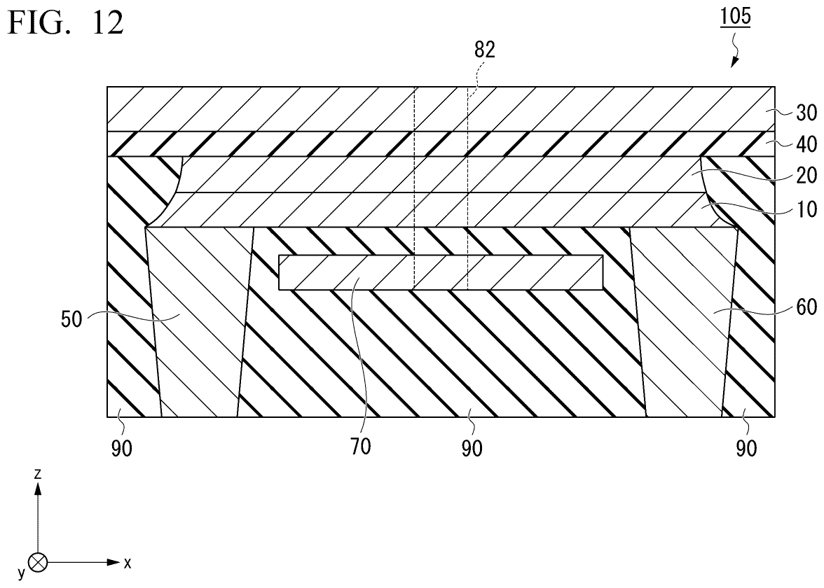

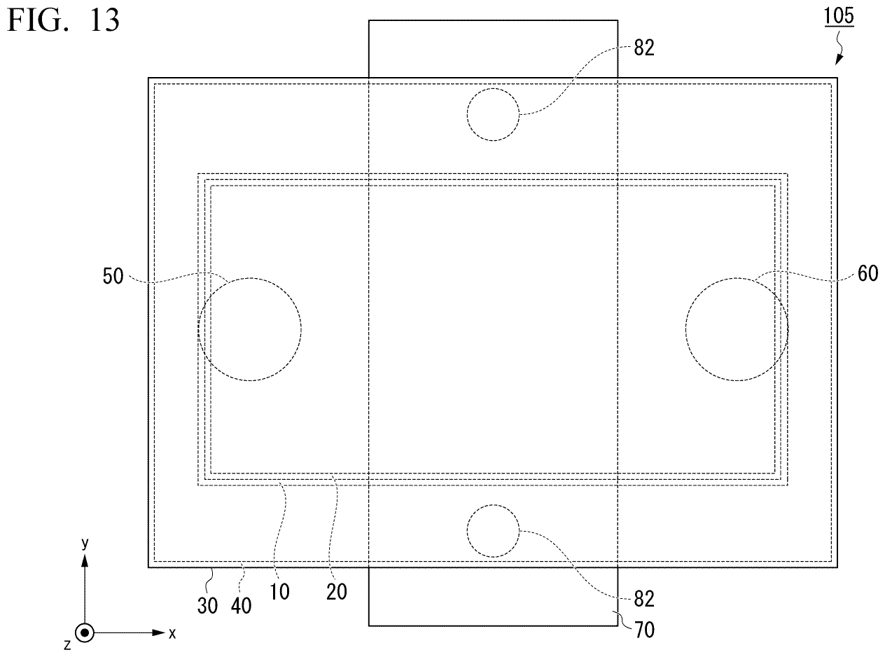

FIG. 12 is a cross-sectional view of a spin inductor 105 according to a sixth embodiment. FIG. 12 is a diagram showing the spin inductor 105 cut along the xz plane passing through the center of the wiring layer 10 in the y direction. In FIG. 12, the components on the front side of the page are illustrated by dotted lines. FIG. 13 is a plan view of the spin inductor 104 according to the fifth embodiment. In FIG. 13, the components located below the first heat dissipation layer 30 are illustrated by dotted lines. In the spin inductor 105 according to the sixth embodiment, the same components as those in the spin inductor 101 according to the second embodiment are designated by the same reference numerals, and the description thereof will be omitted.

The spin inductor 105 according to the sixth embodiment includes the wiring layer 10, the first ferromagnetic layer 20, the first heat dissipation layer 30, the first insulating layer 40, the first via wiring 50, the second via wiring 60, the second heat dissipation layer 70, and a connection portion 82. The spin inductor 105 is different from the spin inductor 101 according to the second embodiment in that the connection portion 82 is provided.

The connection portion 82 connects the first heat dissipation layer 30 and the second heat dissipation layer 70. The connection portion 82 is an example of the second connection portion. The connection portion 82 conducts heat between the first heat dissipation layer 30 and the second heat dissipation layer 70. By connecting the first heat dissipation layer 30 and the second heat dissipation layer 70 with the connection portion 82, it is possible to further suppress heat accumulation in the first heat dissipation layer 30 or the second heat dissipation layer 70.

The spin inductor 105 according to the sixth embodiment has the same effects as the spin inductor 100 according to the second embodiment. Further, since the connection portion 82 is responsible for thermal conduction between the first heat dissipation layer 30 and the second heat dissipation layer 70, local heat accumulation is prevented. Therefore, the spin inductor 105 according to the sixth embodiment has excellent heat dissipation properties.

### Seventh Embodiment

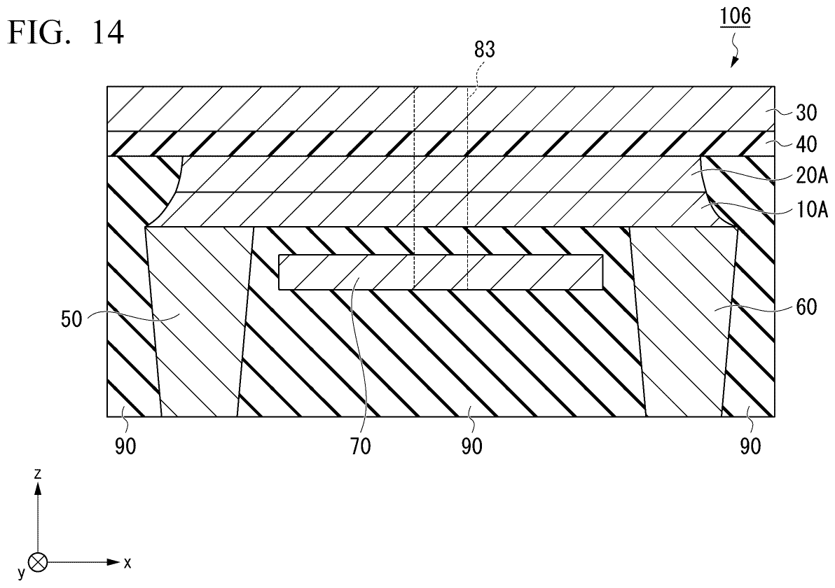

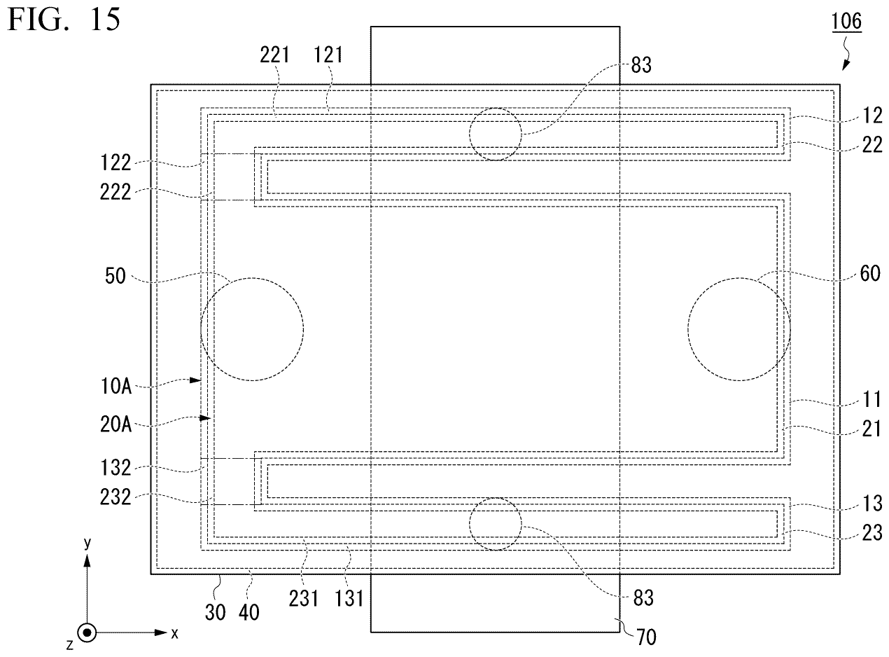

FIG. 14 is a cross-sectional view of a spin inductor 106 according to a seventh embodiment. FIG. 14 is a diagram showing the spin inductor 106 cut along the xz plane passing through the center of the wiring layer 10A in the y direction. In FIG. 14, the components on the front side of the page are illustrated by dotted lines. FIG. 15 is a plan view of the spin inductor 106 according to the seventh embodiment. In FIG. 15, the components located below the first heat dissipation layer 30 are illustrated by dotted lines. In the spin inductor 106 according to the seventh embodiment, the same components as those in the spin inductor 101 according to the second embodiment and the spin inductor 102 according to the third embodiment are designated by the same reference numerals, and the description thereof will be omitted.

The spin inductor 106 according to the seventh embodiment includes the wiring layer 10A, the first ferromagnetic layer 20A, the first heat dissipation layer 30, the first insulating layer 40, the first via wiring 50, the second via wiring 60, the second heat dissipation layer 70, and a connection portion 83. The spin inductor 106 is different from the spin inductor 102 according to the third embodiment in that the second heat dissipation layer 70 and the connection portion 83 are provided.

The connection portion 83 connects the wiring layer 10A, the first heat dissipation layer 30, and the second heat dissipation layer 70. The connection portion 83 is an example of the third connection portion. The connection portion 83 connects, for example, each of the branch portions 12 and 13 to the first heat dissipation layer 30 and the second heat dissipation layer 70. Since almost no current flows through the branch portions 12 and 13, almost no current flows to the connection portion 81, the first heat dissipation layer 30, and the second heat dissipation layer 70. Therefore, the current flowing between the first via wiring 50 and the second via wiring 60 does not substantially reach the first heat dissipation layer 30 and the second heat dissipation layer 70 via the connection portion 83.

The connection portion 83 releases heat from the branch portions 12 and 13 toward the first heat dissipation layer 30 and the second heat dissipation layer 70. Therefore, the connection portion 83 suppresses heat generated in the main portion 11 from accumulating in the branch portions 12 and 13.

The spin inductor 106 according to the seventh embodiment has the same effects as the spin inductor 100 according to the first embodiment. Further, the branch portions 12, 13, 22, and 23 function as a heat dissipation path for the heat generated in the wiring layer 10A. Further, the connection portion 83 releases heat toward the first heat dissipation layer 30 and the second heat dissipation layer 70, thereby suppressing heat accumulation in the branch portions 12, 13, 22, and 23. The spin inductor 106 according to the seventh embodiment has excellent heat dissipation properties.

Here, although an example has been described in which the wiring layer 10A, the first heat dissipation layer 30, and the second heat dissipation layer 70 are connected by the connection portion 83, the spin inductor according to the seventh embodiment is not limited to this example.

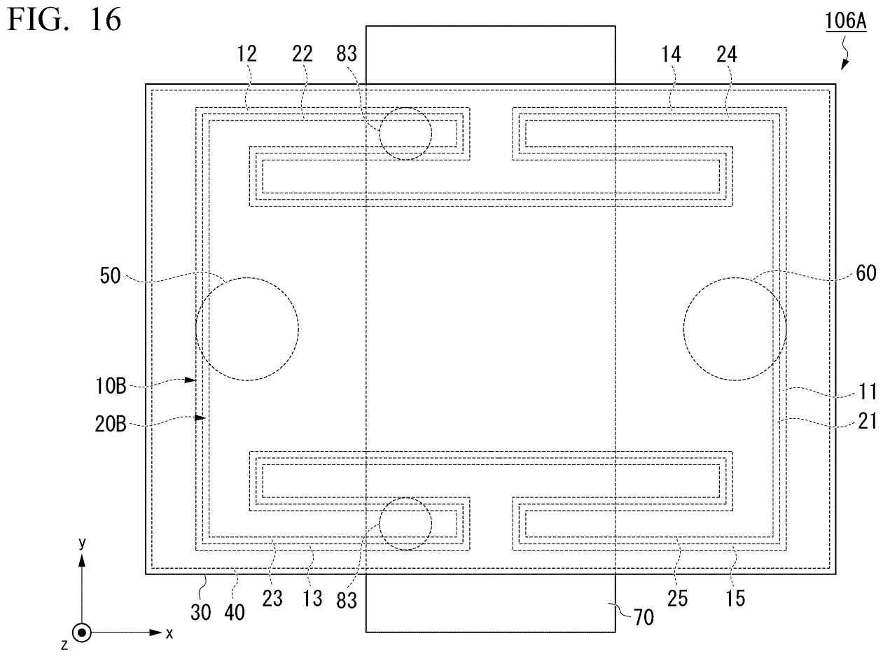

FIG. 16 is a plan view of a first modified example of the spin inductor according to the seventh embodiment. A spin inductor 106B according to the first modified example is different from the spin inductor 106 shown in FIG. 15 in that the wiring layer 10A is the wiring layer 10B and the first ferromagnetic layer 20A is the first ferromagnetic layer 20B. The configurations of the wiring layer 10B and the first ferromagnetic layer 20B are the same as those shown in FIG. 7.

The spin inductor 106A includes the connection portion 83 that connects the wiring layer 10B, the first heat dissipation layer 30, and the second heat dissipation layer 70. The connection portion 83 connects, for example, the branch portion 12 or the branch portion 13 to the first heat dissipation layer 30 and the second heat dissipation layer 70. For example, when one connection portion 83 is connected to the branch portion 12, the other connection portion 83 is preferably connected to the branch portion 13.

Further, the first heat dissipation layer 30 may be divided into a plurality of regions, and each region may be electrically insulated. In this case, since the current that has reached part of the first heat dissipation layer 30 from the connection portion 81 cannot reach other regions, a current path that causes current loss is less likely to be formed.

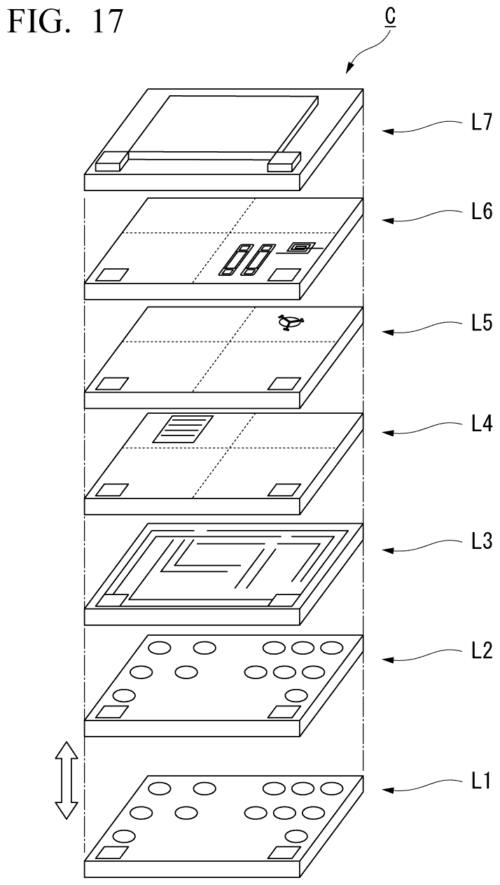

The first to seventh embodiments have been illustrated above, and detailed configurations of the spin inductor have been described. The spin inductor according to the present disclosure is not limited to these exemplary configurations, and various modifications are possible within the scope of the invention. Furthermore, the spin inductor according to the present disclosure can be incorporated into a module for use, for example. FIG. 17 shows an application example of the spin inductor according to this embodiment.

In recent years, there has been a study on integrating semiconductor circuits and devices with specific functions, such as memory, into a single chip. The technology of combining semiconductor circuits and devices such as memory on a single chip is called “chiplet” or “heterointegration.” By integrating these functions into a single chip, latency can be reduced, power consumption can be reduced, and costs can be reduced.

Even with these technologies, passive components need to be placed separately around the chip for the function thereof. Therefore, even if the chips are highly integrated, passive components can be a challenge in miniaturizing the module. By incorporating passive components into chiplets and heterointegration, it is expected that the module can be further miniaturized.

The chip C shown in FIG. 17 includes a semiconductor circuit L1, a connection layer L2, a wiring layer L3, a memory layer LA, a sensor layer L5, an LCR (passive component) layer L6, and an all-solid-state thin-film battery layer L7, which are laminated in this order. Although each layer is bonded to form a single chip, spaces are provided between the layers to facilitate understanding in FIG. 17. The spin inductor according to the present disclosure is formed, for example, in the LCR layer L6. The LCR layer L6 may form not only passive components such as inductors, capacitors, and resistors, which are conventional electronic components, but also spin inductors and spin variable capacitors. The LCR layer L6 is connected to other layers by contact vias, and the entire chip C is used as one module. The spin inductor according to the present disclosure can be applied to a device that has a sensor and a power source as shown in FIG. 17 and can autonomously collect information.

Although some examples of this embodiment have been described above in detail, the present disclosure is not limited to these specific examples. For example, characteristic configurations of the respective embodiments may be combined.

### REFERENCE SIGNS LIST

10, 10A, 10B Wiring layer
11, 21 Main portion
12, 13, 14, 15, 21, 22, 23, 24, 25 Branch portion
20, 20A, 20B First ferromagnetic layer
30 First heat dissipation layer
40 First insulating layer
50 First via wiring
60 Second via wiring
70 Second heat dissipation layer
81, 82, 83 Connection portion
90 Insulating layer
100, 101, 102, 103, 104, 104A, 104B, 105, 106, 106A, 106B Spin inductor
121, 131, 221, 231 First part
122, 132, 222, 232 Second part
G Gap

1. A spin inductor comprising:
a wiring layer;
a first ferromagnetic layer; and
a first heat dissipation layer,
wherein the first ferromagnetic layer is in contact with a first surface of the wiring layer, and
wherein the first heat dissipation layer and the wiring layer sandwich the first ferromagnetic layer in a laminating direction.

2. The spin inductor according to claim 1, further comprising:
a first insulating layer,
wherein the first insulating layer is located between the first ferromagnetic layer and the first heat dissipation layer in the laminating direction.

3. The spin inductor according to claim 2,
wherein the first insulating layer includes an oxide or nitride of at least one selected from the group consisting of Si, Ta, Al, Mg, and Ti.

4. The spin inductor according to claim 1,
wherein the first heat dissipation layer covers all of the wiring layer and the first ferromagnetic layer when viewed from the laminating direction.

5. The spin inductor according to claim 1, further comprising:
a second heat dissipation layer,
wherein the first heat dissipation layer and the second heat dissipation layer sandwich the wiring layer and the first ferromagnetic layer in the laminating direction,

6. The spin inductor according to claim 5, further comprising:
a first via wiring and a second via wiring,
wherein each of the first via wiring and the second via wiring is connected to the wiring layer, and
wherein the second heat dissipation layer is located between the first via wiring and the second via wiring.

7. The spin inductor according to claim 5,
wherein a longitudinal direction of the first heat dissipation layer is a first direction, and
wherein a longitudinal direction of the second heat dissipation layer intersects the first direction.

8. The spin inductor according to claim 1.
wherein the wiring layer includes a main portion through which a current flows in the first direction and a first branch portion which branches off from the main portion, and
wherein at least part of the first branch portion extends along with the main portion at a position offset in a second direction intersecting the first direction.

9. The spin inductor according to claim 8,
wherein the wiring layer further includes a second branch portion, and
wherein at least part of the second branch portion extends along with the main portion at a position offset in the second direction intersecting the first direction, and
wherein a gap is present between the first branch portion and the second branch portion.

10. The spin inductor according to claim 1, further comprising:
a first connection portion that connects the first heat dissipation layer and the wiring layer.

11. The spin inductor according to claim 8, further comprising:
a first connection portion that connects the first heat dissipation layer and the wiring layer,
wherein the first connection portion is connected to the first branch portion of the wiring layer.

12. The spin inductor according to claim 5, further comprising:
a second connection portion that connects the first heat dissipation layer and the second heat dissipation layer.

13. The spin inductor according to claim 5, further comprising:
a third connection portion that connects the wiring layer, the first heat dissipation layer, and the second heat dissipation layer.

14. The spin inductor according to claim 1,
wherein the first heat dissipation layer includes any one selected from the group consisting of Ta, NiCr, Ti, SiN, TiN, ferrite, Ni, and Fe.

15. The spin inductor according to claim 1,
wherein the wiring layer is configured to inject spins into the first ferromagnetic layer, and
wherein the magnetization of the first ferromagnetic layer is configured to precess with the injected spins.
